(19) United States
(12) Patent Application Publication
(10) Pub. No.: US 2022/0376296 A1
(43) Pub. Date: Nov. 24, 2022

(54) SINGLE-ION CONDUCTING POLYMER SOLID ELECTROLYTE AND ITS METHOD OF PREPARATION

(71) Applicant: INDUSTRY-ACADEMIC COOPERATION FOUNDATION, YONSEI UNIVERSITY, Seoul (KR)

(72) Inventors: Kyeong Seok OH, Seoul (KR); Sang Young LEE, Seoul (KR)

(21) Appl. No.: 17/657,879

(22) Filed: Apr. 4, 2022

(30) Foreign Application Priority Data
Apr. 23, 2021 (KR) 10-2021-0052976
Aug. 30, 2021 (KR) 10-2021-0114447

(51) Int. Cl. H01M 10/0565; H01M 10/0525

(52) U.S. Cl. CPC H01M 10/0565; H01M 10/0525; H01M 2300/0091; H01M 2300/0082

(57) ABSTRACT

The present disclosure relates to a single-ion solid electrolyte and its method of preparation. More particularly, the present disclosure relates to a single-ion conducting polymer solid electrolyte containing a network polymer, inorganic nanoparticles, and an electrolyte, wherein the network polymer contains a structural unit containing a cationic group, and its method of preparation.

### TECHNICAL FIELD

The following disclosure relates to a single-ion solid electrolyte and its method of preparation.

### BACKGROUND

Lithium ion batteries have a relatively high energy density and long lifespan characteristics, and thus have been widely used throughout industries as small batteries used in mobile phones, laptops, and the like and medium and large batteries used in electric vehicles and large-capacity energy storage systems (ESS).

However, since a flammable organic liquid electrolyte is used in the lithium ion battery, when thermal runaway occurs due to overcharging, internal short circuit, or the like, a decomposition reaction between electrodes and the electrolyte occurs, which leads to fire or explosion. In order to solve such a problem, studies on an all-solid-state lithium-metal battery obtained by replacing an organic liquid electrolyte with a solid electrolyte have been actively conducted.

As an electrolyte applied to the all-solid-state lithium-metal battery, an inorganic solid electrolyte or a polymer solid electrolyte is used. The inorganic solid electrolyte has a high cation transference number and a high ion conductivity, but requires a high temperature and a high pressure during a process of manufacturing and driving a cell and has problems such as a high interfacial resistance with electrodes and instability with a lithium-metal anode. In particular, dendrites may grow through voids generated by a grain boundary defect of the inorganic solid electrolyte.

On the other hand, the polymer solid electrolyte is superior to the inorganic solid electrolyte in terms of flexibility, lightness, processability, and affordability. However, in general, the polymer solid electrolyte has a relatively low lithium (Li)-ion transference number because it contains a dual-ion conductor in which both a lithium cation and its corresponding anion are mobile. Such a phenomenon occurs because the lithium cation is bound to a Lewis basic site of a polymer matrix, and thus mobility thereof becomes lower than that of the anion. Therefore, the Li-ion transference number of the dual-ion conductor is generally 0.5 or less.

In addition, in the polymer solid electrolyte, lithium ions and their corresponding anions move in opposite directions during discharge, and the anions may have a tendency to accumulate toward the anode, which causes a concentration gradient and cell polarization. When this phenomenon continues, a battery performance may be deteriorated.

### RELATED ART DOCUMENT

### Patent Document

Korean Patent Laid-Open Publication No. 10-2021-0015103 (Feb. 10, 2021)

### SUMMARY

An embodiment of the present disclosure is directed to providing a single-ion conducting polymer solid electrolyte having excellent ion conductivity and lithium-ion transference number.

Another embodiment of the present disclosure is directed to providing a method of preparing a single-ion conducting polymer solid electrolyte capable of solving a high interfacial resistance with electrodes and instability with a lithium-metal anode and manufacturing an all-solid-state lithium-metal battery at room temperature and normal pressure by a simple process.

In one general aspect, a single-ion conducting polymer solid electrolyte contains a network polymer, inorganic nanoparticles, and an electrolyte, wherein the network polymer contains a structural unit containing a cationic group.

The cationic group may include a quaternary ammonium group.

The inorganic nanoparticles may include cationic inorganic nanoparticles.

The network polymer may be polymerized from a photocurable composition containing a cationic monomer and a polyfunctional monomer.

A ratio of a molar content of the cationic monomer to a total molar content of the photocurable composition may be 10 to 70 mol %.

The cationic monomer may contain two or more polymerizable functional groups.

The polyfunctional monomer may contain a polyol ester-based acrylic compound.

The inorganic nanoparticles and the electrolyte may be contained in the single-ion conducting polymer solid electrolyte in amounts of 10 to 300 parts by weight and 50 to 300 parts by weight, respectively, with respect to 100 parts by weight of the photocurable composition.

The cationic inorganic nanoparticle may be coated with a metal oxide layer.

The metal oxide layer may contain titanium dioxide and silicon dioxide.

The single-ion conducting polymer solid electrolyte may have an ion conductivity of 1.0×10⁻⁷ to 1.0×10⁻² S/cm and a lithium-ion (Li⁺) transference number of 0.5 to 1.0.

In another general aspect, a lithium-metal battery contains the single-ion conducting polymer solid electrolyte.

The lithium-metal battery may be operated at 4.0 V or higher.

In still another general aspect, a method of preparing a single-ion conducting polymer solid electrolyte includes: mixing inorganic nanoparticles with a curable composition containing a polyfunctional monomer, a cationic monomer, and an electrolyte; and curing the curable composition in which the inorganic nanoparticles are dispersed.

In still another general aspect, a method of manufacturing an all-solid-state lithium-metal battery includes: mixing inorganic nanoparticles with a first curable composition containing a polyfunctional monomer, a cationic monomer, and an electrolyte; forming a first curable composition layer by printing the first curable composition in which the inorganic nanoparticles are dispersed on a lithium-metal layer; preparing a single-ion conducting polymer solid electrolyte by curing the first curable composition layer; forming a cathode layer by printing a cathode slurry containing a cathode active material, a conductive material, and a second curable composition on the single-ion conducting polymer solid electrolyte; and curing the cathode layer.

The second curable composition may contain a polyfunctional monomer, a cationic monomer, and an electrolyte.

The curing may be performed by light irradiation.

Other features and aspects will be apparent from the following detailed description, the drawings, and the claims.

### BRIEF DESCRIPTION OF THE FIGURES

FIG. 1 is a schematic view and a cross-sectional SEM image of an all-solid-state lithium-metal battery of the present disclosure.

FIG. 2 is a graph obtained by measuring viscosities of solid electrolyte pastes of Examples 1, 4, and 5.

FIGS. 3A and 3B are graphs obtained by measuring zeta potentials and FT-IRs of metal oxides of Examples 1 and 6.

FIG. 4 is a graph obtained by measuring current densities according to voltages of solid electrolytes of Example 1 and Comparative Example 1.

FIG. 5 is a graph showing electrochemical impedance spectroscopy (EIS) spectra of Example 1 and Comparative Example 4.

FIG. 6 is a graph obtained by thermogravimetric analysis (TGA) of the solid electrolyte paste of Example 1.

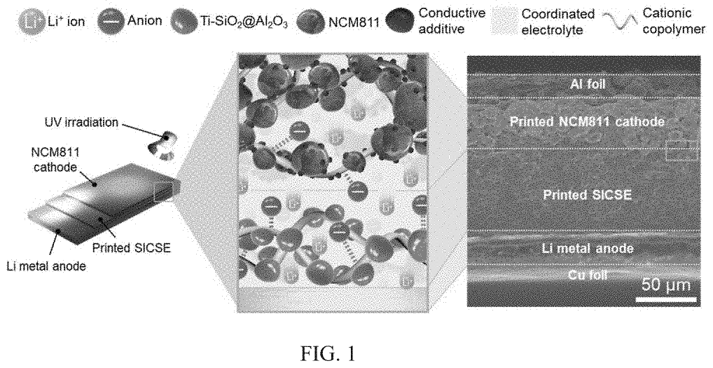

### DETAILED DESCRIPTION

Hereinafter, the present disclosure will be described in more detail with reference to specific exemplary embodiments or exemplary embodiments including the accompanying drawings. However, each of the following specific exemplary embodiments or exemplary embodiments is merely one reference example for describing the present disclosure in detail, and the present disclosure is not limited thereto and may be implemented in various forms.

In addition, unless otherwise defined, all the technical terms and scientific terms have the same meanings as commonly understood by those skilled in the art to which the present disclosure pertains. The terms used in the description of the present disclosure are merely used to effectively describe a specific exemplary embodiment, but are not intended to limit the present disclosure.

In addition, unless the context clearly indicates otherwise, the singular forms used in the specification and the scope of the appended claims are intended to include the plural forms.

In addition, unless explicitly described to the contrary, “comprising” any components will be understood to imply further inclusion of other components rather than the exclusion of any other components.

A solid electrolyte according to the related art contains a dual-ion conductor in which both a lithium cation and its corresponding anion are mobile. Since the lithium cation is bound to a Lewis basic site of a polymer matrix, mobility thereof is inevitably lower than that of the anion.

Therefore, the present inventors have found that the above problem is solved when a single-ion conducting polymer solid electrolyte contains a network polymer, inorganic nanoparticles, and an electrolyte, and the network polymer contains a structural unit containing a cationic group so that the solid electrolyte has an excellent ion conductivity and a high lithium-ion transference number.

Since the network polymer has only a cationic group as a single-ion, mobility of the lithium cations may be increased, while their corresponding anions may be fixed. Therefore, the single-ion conducting polymer solid electrolyte may have a high lithium-ion transference number.

According to an exemplary embodiment of the present disclosure, the cationic group may include a quaternary ammonium group. According to a non-limiting example, the quaternary ammonium group contained as a structural unit of the network polymer may be included in a polymer main chain and may be represented by *—NRₐR_{b}—*. Rₐ and R_{b} may be each independently hydrogen or C₁-C₁₀ alkyl, and specifically, Rₐ and R_{b} may be each independently C₁-C₄ alkyl.

The quaternary ammonium group may include a functional group derived from a quaternary ammonium compound. As the network polymer contains the functional group derived from a quaternary ammonium compound, the corresponding anions may be fixed by electrical combination.

According to an exemplary embodiment of the present disclosure, the network polymer may be polymerized from a photocurable composition containing a cationic monomer and a polyfunctional monomer. Therefore, a network polymer in which the cationic groups are uniformly dispersed may be provided.

According to an exemplary embodiment of the present disclosure, a ratio of a molar content of the cationic monomer to a total molar content of the photocurable composition may be 10 to 70 mol %, specifically, may be 30 to 60 mol %, and more specifically, may be 45 to 55 mol %, but is not limited thereto.

As the ratio of the molar content (%) of the cationic monomer to the total molar content of the photocurable composition satisfies the above range, the lithium-ion transference number of the single-ion conducting polymer solid electrolyte may be excellent, and flexibility and durability of the single-ion conducting polymer solid electrolyte may also be excellent.

According to an exemplary embodiment of the present disclosure, the cationic monomer may contain two or more polymerizable functional groups, specifically, may contain 2 to 10 polymerizable functional groups, and more specifically, may contain 2 to 6 polymerizable functional groups, but is not limited thereto.

Since the cationic monomer contains two or more polymerizable functional groups, the cationic monomer may be polymerized into a polymer having a network form. As an example, the polymerizable functional group may be acryl or vinyl, but is not limited thereto.

In addition, the cationic monomer may be a monomer containing a quaternary ammonium group.

Specifically, the cationic monomer containing two or more polymerizable functional groups may be represented by the following Chemical Formula 1:

N⁺(R₅)(R₆)(R₇)(R₈)X [symbol] Chemical Formula 1

wherein R₅ to R₈ are each independently hydrogen or C₁-C₃₀ alkyl or C₂-C₃₀ alkenyl, one of R₅ to R₈ is essentially C₂-C₃₀ alkenyl, and X is halogen.

Specifically, in Chemical Formula 1, R₅ and R₆ may be each independently C₁-C₁₀ alkyl and R₇ and R₈ may be each independently C₂-C₁₀ alkenyl.

Specifically, in Chemical Formula 1, R₁ and R₂ may be each independently C₁-C₄ alkyl and R₇ and R₈ may be each independently C₂-C₄ alkenyl.

Specifically, each of R₇ and R₈ may be an acryl or vinyl group.

As a specific example, the cationic monomer containing two or more polymerizable functional groups may contain diallyldimethyl ammonium bromide or diallyldimethyl ammonium chloride, but is not limited thereto.

According to an exemplary embodiment of the present disclosure, the polyfunctional monomer may contain a polyol ester-based acrylic compound.

The polyol ester-based acrylic compound may contain two or more polymerizable functional groups, specifically, may contain 2 to 10 polymerizable functional groups, and more specifically, may contain 2 to 6 polymerizable functional groups, but is not limited thereto.

According to a non-limiting example, it may be preferable that the number of polymerizable functional groups of the polyol ester-based acrylic compound is greater than the number of polymerizable functional groups of the cationic monomer.

In addition, an average molecular weight of the polyol ester-based acrylic compound may be 100 to 1,000 g/mol, specifically, may be 100 to 500 g/mol, and more specifically, may be 100 to 300 g/mol, but is not limited thereto.

As a specific example, the polyol ester-based acrylic compound may be one or a mixture of two or more selected from ethoxylated trimethylolpropane triacrylate, di(trimethylolpropane) tetraacrylate, diethylene glycol diacrylate, diethylene glycol dimethacrylate, ethylene glycol dimethacrylate, dipropylene glycol diacrylate, dipropylene glycol dimethacrylate, ethylene glycol divinyl ether, diethylene glycol divinyl ether, triethylene glycol dimethacrylate, dipentaerythritol pentaacrylate, trimethylolpropane triacrylate, trimethylolpropane trimethacrylate, propoxylated trimethylolpropane triacrylate, trimethylolpropane triacrylate, polyethylene glycol diacrylate, and polyethylene glycol dimethacrylate, more specifically, may be one or a mixture of two or more selected from ethoxylated trimethylolpropane triacrylate, di(trimethylolpropane) tetraacrylate, dipentaerythritol pentaacrylate, trimethylolpropane triacrylate, trimethylolpropane trimethacrylate, propoxylate trimethylolpropane triacrylate, trimethylolpropane triacrylate, and polyethylene glycol diacrylate, and still more specifically, may be one or a mixture of two or more selected from ethoxylated trimethylolpropane triacrylate, trimethylolpropane trimethacrylate, propoxylate trimethylolpropane triacrylate, and trimethylolpropane triacrylate, but is not limited thereto.

According to an exemplary embodiment of the present disclosure, the inorganic nanoparticles and the electrolyte may be contained in the single-ion conducting polymer solid electrolyte in amounts of 10 to 300 parts by weight and 50 to 300 parts by weight, respectively, with respect to 100 parts by weight of the photocurable composition, specifically, in amounts of 50 to 200 parts by weight and 90 to 200 parts by weight, respectively, with respect to 100 parts by weight of the photocurable composition, and more specifically, in amounts of 70 to 150 parts by weight and 100 to 150 parts by weight, respectively, with respect to 100 parts by weight of the photocurable composition, but are not limited thereto.

The inorganic nanoparticles and the electrolyte are mixed in the single-ion conducting polymer solid electrolyte in the above weight ranges, such that the single-ion conducting polymer solid electrolyte may have a high ion conductivity and a high lithium-ion transference number, and may have a viscosity at which a printing technique to be described below may be easily introduced.

According to an exemplary embodiment of the present disclosure, the viscosity of the solid electrolyte may be a viscosity (cP) of 10² to 10⁵, and specifically, may be a viscosity of 10² to 10⁴, but is not limited thereto.

A weight average molecular weight of the network polymer may be 10,000 to 500,000 g/mol, specifically, may be 50,000 to 400,000 g/mol, and more specifically, may be 100,000 to 350,000 g/mol, but is not limited thereto.

According to an exemplary embodiment of the present disclosure, the inorganic nanoparticles may be formed of one or a mixture of two or more selected from alumina (Al₂O₃), silica (SiO₂), titania (TiO₂), zirconia (zirconium dioxide (ZrO₂)), zinc oxide (ZnO), antimony oxide, cerium oxide (CeO₂), yttrium oxide (Y₂O₃), talc, calcium carbonate, aluminum hydroxide, active clay, mica, barium sulfate, zeolite, barium titanate, boron nitride, forsterite, lanthanum oxide (La₂O₃), tantalum oxide (tantalum pentoxide (Ta₂O₅)), barium titanate (BaTiO₃), barium zirconate titanate (BZT), hafnium silicate (hafnon (HfSiO₄)), lanthanum aluminate (LaAlO₃), silicon nitride (Si₃N₄), strontium titanate (SrTiO₃), barium strontium titanate (BST), lead zirconate titanate (PZT), calcium copper titanate (CCTO), hafnium oxide (HfO₂), apatite, hydroxyapatite (Ca₁₀(PO₄)₆(OH)₂), tricalcium phosphate (Ca₃(PO₄)₂), bioglass (CaO—SiO₂—P₂O₅ or Na₂O—CaO—SiO₂), lithium silicate, lithium borate, lithium phosphate, lithium phosphoronitride, lithium silicosulfide, lithium borosulfide, lithium aluminosulfide, and lithium phosphosulfide, but the present disclosure is not limited thereto.

The inorganic nanoparticle may have a form such as a powder, a wire, a tube, a fiber, or a needle, and a size of the inorganic nanoparticle may be 1 nm to 900 nm. The size may refer to a particle diameter, a diameter, a length, a thickness, or the like depending on the form of the particle.

The single-ion conducting polymer solid electrolyte further contains the inorganic nanoparticles, such that the ion conductivity may be improved, and the ion conductivity may be secured in a battery without separate aging unlike a liquid electrolyte.

According to an exemplary embodiment of the present disclosure, the inorganic nanoparticles may be cationic inorganic nanoparticles.

The single-ion conducting polymer solid electrolyte contains the cationic inorganic nanoparticles, such that the cationic inorganic nanoparticles may be more strongly combined with the corresponding anions, and the lithium-ion transference number may be further increased.

According to an exemplary embodiment of the present disclosure, the cationic inorganic nanoparticles may include particles obtained by coating surfaces of the inorganic nanoparticles with a metal oxide layer.

According to an exemplary embodiment of the present disclosure, the metal oxide may be one or a mixture of two or more selected from silicon oxide, titanium oxide, boron oxide, yttrium oxide, magnesium oxide, iron oxide, zirconium oxide, chromium oxide, tin oxide, hafnium oxide, and beryllium oxide, specifically, may be one or a mixture of two or more selected from silicon oxide, titanium oxide, boron oxide, magnesium oxide, iron oxide, zirconium oxide, and tin oxide, and more specifically, may be one or a mixture of two or more selected from silicon oxide, titanium oxide, boron oxide, and magnesium oxide, but is not limited thereto.

According to an exemplary embodiment of the present disclosure, the metal oxide layer may contain titanium dioxide and silicon dioxide.

The metal oxide layer may contain titanium dioxide and silicon dioxide, such that the surface of the inorganic nanoparticle may have a more excellent positive charge, and the lithium-ion transference number may be significantly excellent.

According to an exemplary embodiment of the present disclosure, an ion conductivity of the single-ion conducting polymer solid electrolyte may be 1.0×10⁻⁷ to 1.0×10⁻² S/cm, specifically, may be 1.0×10⁻⁶ to 1.0×10⁻³ S/cm, and more specifically, may be 1.0×10⁻⁵ to 1.0×10⁻³ S/cm, but is not limited thereto.

In addition, a lithium-ion (Lit) transference number of the single-ion conducting polymer solid electrolyte may be 0.5 to 1.0, specifically, may be 0.7 to 1.0, and more specifically, may be 0.9 to 1.0, but is not limited thereto.

According to an exemplary embodiment of the present disclosure, a lithium-metal battery containing the single-ion conducting polymer solid electrolyte may be provided.

The lithium-metal battery contains the single-ion conducting polymer solid electrolyte, such that a high ion conductivity and a high lithium-ion transference number may be implemented, and the lithium-metal battery may be operated at a high voltage.

The voltage at which the lithium-metal battery may be operated may be 4 V or higher, specifically, may be 5 V or higher, and more specifically, may be 6 V or higher, but is not limited thereto.

Next, a method of preparing a single-ion conducting polymer solid electrolyte will be described.

According to an exemplary embodiment of the present disclosure, a method of preparing a single-ion conducting polymer solid electrolyte may include: mixing inorganic nanoparticles with a curable composition containing a polyfunctional monomer, a cationic monomer, and an electrolyte; and curing the curable composition in which the inorganic nanoparticles are dispersed.

Since the descriptions of the polyfunctional monomer, the cationic monomer, and the electrolyte have been described above, overlapping descriptions will be omitted.

The electrolyte is not limited as long as it is a commonly used electrolyte. Specifically, the electrolyte may be a mixed solution in which a lithium salt is dissolved, and the lithium salt may include one or a mixture of two or more selected from the group consisting of lithium hexafluorophosphate (LiPF₆), lithium tetrafluoroborate (LiBF₄), lithium hexafluoroantimonate (LiSbF₆), lithium hexafluoroarsenate (LiAsF₆), lithium difluoromethanesulfonate (LiC₄F₉SO₃), lithium perchlorate (LiClO₄), lithium aluminate (LiAlO₂), lithium tetrachloroaluminate (LiAlCl₄), lithium chloride (LiCl), lithium iodide (LiI), lithium bisoxalatoborate (LiB (C₂O₄)₂), and lithium trifluoromethanesulfonyl imide (LiTFSI), and specifically, may include one or a mixture of two or more selected from lithium tetrafluoroborate (LiBF₄), lithium perchlorate (LiClO₄), and lithium trifluoromethanesulfonyl imide (LiTFSI), but is not limited thereto.

In addition, the curable composition may further contain a photoinitiator. The photoinitiator generates a photocuring reaction by generation of radicals during light irradiation, and for example, the photoinitiator may include one or a mixture of two or more selected from anthraquinone, anthraquinone-2-sulfonic acid sodium salt monohydrate, (benzene)tricarbonylchromium, benzyl, benzoin ethyl ether, benzoin isobutyl ether, benzoin methyl ether, benzophenone, 4-benzoylbiphenyl, 4,4′-bis(diethylamino)benzophenone, 4,4′-bis(dimethylamino)benzophenone, dibenzosuberenone, 2,2-dimethoxy-2-phenylacetophenone, 3,4-dimethylbenzophenone, 3′-hydroxyacetophenone, 2-hydroxy-2-methylpropiophenone, 2-hydroxy-4′-(2-hydroxyethoxy)-2-methylpropiophenone, 1-hydroxycyclohexyphenyl ketone, methylbenzoyl formate, diphenyl(2,4,6-trimethylbenzoyl)-phosphine oxide, phenyl bis(2,4,6-trimethyl benzoyl) phosphine oxide, 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-dimethylamino-2-(4-methyl-benzyl)-1-(4-morpholin-4-yl-phenyl)-butan-1-one, bis(5 -2,4-cyclopentadien-1-yl)-bis(2,6-difluoro-3(1h-pyrrol-1-yl)-phenyetitanium, 2-isopropyl thioxanthone, 2-ethyl anthraquinone, 2,4-diehyl thioxanthone, benzyl dimethyl ketal, benzophenone, 4-chloro benzophenone, methyl-2-benzoylbenzoate, 4-phenyl benzophenone, 2,2′-bis(2-chlorophenyl)-4,4′,5,5′-tetraphenyl-1,2′-biimidazole, 2,2′,4-tris(2-chlorophenyl)-5-(3 ,4-dimethoxypenly)-4′,5′-diphenyl-1,1′-biimidazole, 4-phenoxy-2′,2′-dichloro acetophenone, ethyl-4-(dimethylamino)benzoate, isoamyl 4-(dimethylamino)benzoate, 2-ethylhexyl-4-(dimethylamino)benzoate, 4,4′-bis(diethylamino)benzophenone, 4-(4′-methylphenylthio)-benzophenone, 1,7-bis(9-acridinyl)heptane, n-phenyl glycine, 2-hydroxy-2-methylpropiophenone, and 2-hydroxy-2-methyl-1-phenyl-propan-1-one (HMPP), but is not limited thereto.

The photoinitiator may be contained in the solid electrolyte in an amount of 1 to 10 parts by weight with respect to 100 parts by weight of the photocurable composition, but is not limited thereto.

According to an exemplary embodiment of the present disclosure, the inorganic nanoparticle may be coated with a metal oxide layer.

The method of coating the inorganic nanoparticles with a metal oxide layer may be performed by adding the inorganic nanoparticles to a mixed solution in which a metal precursor is mixed with an organic solvent, but is not limited thereto.

A thickness of the metal oxide layer coated to the inorganic nanoparticle may be 1 nm to 50 nm, but is not limited thereto.

In the curing of the curable composition, a curing method may include a photocuring method, and the curing may be performed using, for example, ultraviolet rays, visible light, a laser beam, radiation, an electron beam, or the like.

In the photocuring, a photocuring dose may be 10,000 mW/cm⁻² or less, specifically, may be 1,000 to 5,000 mW/cm⁻², and more specifically, may be 1,500 to 4,000 mW/cm⁻², and a photocuring time may be 1 to 600 seconds, specifically, may be 10 to 300 seconds, and more specifically, may be 20 to 100 seconds, but the present disclosure is not limited thereto.

Next, a method of manufacturing an all-solid-state lithium-metal battery will be described.

According to an exemplary embodiment of the present disclosure, a method of manufacturing an all-solid-state lithium-metal battery may include: mixing inorganic nanoparticles with a first curable composition containing a polyfunctional monomer, a cationic monomer, and an electrolyte; forming a first curable composition layer by printing the first curable composition in which the inorganic nanoparticles are dispersed on a lithium-metal layer; preparing a single-ion conducting polymer solid electrolyte by curing the first curable composition layer; forming a cathode layer by printing a cathode slurry containing a cathode active material, a conducting agent, and a second curable composition on the single-ion conducting polymer solid electrolyte; and curing the cathode layer.

The printing may be performed by a printing process, and specifically, may be performed by a solvent-free printing process. By performing the solvent-free printing process, the curable composition may be uniformly coated to the lithium-metal layer, and there is no need to add a separate drying process.

The printing method may include a coating process by slot die coating, bar coating, comma coating, screen coating, spray coating, doctor blade coating, a brush, or the like, but is not limited thereto.

The cathode slurry may be coated to the single-ion conducting polymer solid electrolyte through the solvent-free printing process.

The cathode slurry may be provided by mixing a cathode active material, a conducting agent, and a second curable composition, and the cathode slurry may be cured by the second curable composition.

The second curable composition may contain a polyfunctional monomer, a cationic monomer, and an electrolyte, and the second curable composition may further contain a photoinitiator. The second curable composition may be the same as the first curable composition.

Since the descriptions of the polyfunctional monomer, the cationic monomer, the electrolyte, and the photoinitiator have been described above, overlapping descriptions will be omitted.

As the cathode active material, a cathode active material commonly used in the art may be used. Specific examples of the cathode active material include, but are not limited to, lithium cobalt oxide (LiCoO₂), spinel crystalline lithium manganese composite oxide (LiMn₂O₄), lithium manganese composite oxide (LiMnO₂), nickel lithium composite oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium composite oxide (LiNbO₂), lithium iron composite oxide (LiFeO₂), lithium magnesium composite oxide (LiMgO₂), lithium copper composite oxide (LiCuO₂), lithium zinc complex oxide (LiZnO₂), lithium molybdenum composite oxide (LiMoO₂), lithium tantalum composite oxide (LiTaO₂), lithium tungsten composite oxide (LiWO₂), lithium permanganate-nickel-cobalt composite oxide (xLi₂MnO₃ (1-x)LiMn1-y-zNiyCozO₂), lithium-nickel-cobalt-aluminum composite oxide (LiNi_{0.8}Co_{0.15}Al_{0.05}O₂), lithium-nickel-cobalt-manganese composite oxide (LiNi_{0.33}Co_{0.33}Mn_{0.33}O₂, LiNi_{0.4}Co_{0.2}Mn₄O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, or LiNi_{0.8}Co_{0.2}Mn_{0.1}O₂), and oxide manganese nickel (LiNi_{0.5}Mn_{1.5}O₄).

As the conducting agent, carbon black such as acetylene black, Ketjen black, channel black, furnace black, lamp black, or thermal black; a conducting fiber such as a carbon fiber or a metal fiber; metal powder such as carbon fluoride powder, aluminum powder, or nickel powder; conductive whiskey such as zinc oxide or potassium titanate; a conductive metal oxide such as titanium oxide; and a polyphenylene derivative may be used. The conducting agent is not particularly limited as long as it has conductivity without causing a chemical change in a battery.

An all-solid-state lithium-metal battery may be manufactured by curing the coated cathode slurry.

Since the curing method has been described above, an overlapping description will be omitted.

A current collector of the all-solid-state lithium-metal battery is not limited as long as it is commonly used, and specifically, an aluminum metal may be used for a cathode, and a copper metal may be used for an anode.

Hereinafter, the present disclosure will be described in more detail with reference to Examples and Comparative Examples. However, the following Examples and Comparative Examples are only examples for describing the present disclosure in more detail, and the present disclosure is not limited by the following Examples and Comparative Examples.

### Measurement of Ion Conductivity

The ion conductivity was measured based on electrochemical impedance spectroscopy (EIS) analysis. An impedance was measured at a frequency range of 10⁻² to 10⁶ Hz, an amplitude of 10 mV, and −20 to 100° C., and an ion conductivity was measured by substituting the impedance value into the following Equation 1:

σ=L/RA Equation 1

wherein σ is an ion conductivity, L is a thickness of a pellet, R is an impedance, and A is an area of an electrode.

### Measurement of Lithium-Ion Transference Number

The lithium-ion transference number (t_{Li}⁺) was measured using a potentiostatic polarization method. t_{Li}⁺ was calculated by measuring current densities (I₀ and Iₛ) and interfacial resistances (R₀ and Rₛ) before and after polarization through the following Equation 2:

t_{Li+}=Iₛ(ΔV−I₀R₀)/I₀((ΔV−IₛRₛ) Equation 2

### Measurement of Electrochemical Stability

The electrochemical stability was measured by an electrochemical floating test, and the measurement was performed at a rate of 0.1 mVs⁻¹.

### Production of Polyfunctional Monomer Containing Cation

5 mol of allyldimethylamine (TCL chemicals) was dissolved in 100 ml of acetonitrile (Aldrich), and cooling was performed at 0° C., thereby preparing a mixed solution.

55 mol of allyl bromide (Aldrich) was added dropwise to the mixed solution for 30 minutes, and then, the mixed solution was allowed to proceed a reaction at room temperature for 12 hours.

After the reaction was completed, the acetonitrile contained in the mixed solution was evaporated using a rotary evaporator to prepare a DADMA-Br compound.

The DADMA-Br compound was purified using 20 ml of ethyl acetate and 20 ml of diethyl ether, and the purified DADMA-Br compound was dried in a vacuum oven for 12 hours.

50 mol of the dried DADMA-Br compound was dissolved in 100 ml of distilled water to prepare an aqueous solution. 50 mol of LiTFSI was added to the aqueous solution, and the solution was stirred for 12 hours, thereby preparing DADMA-LiTFSI.

After the reaction was completed, the prepared DADMA-LiTFSI was extracted from the aqueous solution with 50 ml of dichloromethane to prepare an extract solution. The extract solution was purified by an alumina oxide column.

The purified extract solution was dried in a vacuum oven to obtain a DADMA-LiTFSI ionic monomer that was a polyfunctional monomer containing a cation.

### Preparation of Photocurable Composition

66.7 parts by weight of ethoxylated trimethylolpropane triacrylate (ETPTA) was mixed with 100 parts by weight of the DADMA-LiTFSI ionic monomer to prepare a mixture.

7 parts by weight of 2-hydroxy-2-methyl-1-phenyl-propan-1-one (HMPP) and 135.3 parts by weight of an electrolyte composition were mixed with 100 parts by weight of the mixture to prepare a photocurable composition.

The electrolyte composition was a mixed solution of 4 M LiFSI, and the mixed solution was a solution in which propylene carbonate and fluoroethylene carbonate were mixed at a volume ratio of 93:7.

### Preparation of Cathode Slurry

7.36 parts by weight of a conducting agent (carbon black, supur P) and 39.7 parts by weight of the prepared photocurable composition were mixed with 100 parts by weight of a cathode active material (NCM811, LiNi_{0.8}Co_{0.1}Mn_{0.1}O₂) to prepare a cathode slurry.

The cathode slurry was cured with UV rays to prepare a cathode cured product. As a result of measuring the cathode cured product by GPC, a weight average molecular weight thereof was 309,262 g/mol.

### Preparation of Ti—SiO₂@Al₂O₃

30 parts by weight of tetraethyl orthosilicate (TEOS) and 30 parts by weight of titanium(IV) isopropoxide (TTIP) were mixed with 100 parts by weight of an ethylacetate (EA) solution to prepare a mixed solution.

100 parts by weight of aluminum oxide particles (Aldrich) having an average particle size of 500 nm were mixed with 100 parts by weight of the mixed solution, and stirring was performed for 30 minutes, thereby preparing Ti—SiO₂@Al₂O₃ nanoparticles. The Ti—SiO₂@Al₂O₃ nanoparticles were dried at room temperature.

The dried Ti—SiO₂@Al₂O₃ nanoparticles were primarily purified with hydrochloric acid, and then, the primarily purified Ti—SiO₂@Al₂O₃ nanoparticles were secondarily purified with water and ethanol. The secondarily purified Ti—SiO₂@Al₂O₃ nanoparticles were vacuum dried at 60° C.

### Preparation of SiO₂@Al₂O₃

30 parts by weight of tetraethyl orthosilicate (TEOS) was mixed with 100 parts by weight of an ethylacetate (EA) solution to prepare a mixed solution.

100 parts by weight of aluminum oxide particles (Aldrich) having an average particle size of 500 nm were mixed with 100 parts by weight of the mixed solution, and stirring was performed for 30 minutes, thereby preparing SiO₂@Al₂O₃ nanoparticles. The SiO₂@Al₂O₃ nanoparticles were dried at room temperature.

The dried SiO₂@Al₂O₃ nanoparticles were primarily purified with hydrochloric acid, and then, the primarily purified SiO₂@Al₂O₃ nanoparticles were secondarily purified with water and ethanol. The secondarily purified SiO₂@Al₂O₃ nanoparticles were vacuum dried at 60° C.

### Preparation of TiO₂@Al₂O₃

30 parts by weight of titanium(IV) isopropoxide (TTIP) was mixed with 100 parts by weight of an ethylacetate (EA) solution to prepare a mixed solution.

100 parts by weight of aluminum oxide particles (Aldrich) having an average particle size of 500 nm were mixed with 100 parts by weight of the mixed solution, and stirring was performed for 30 minutes, thereby preparing TiO₂@Al₂O₃ nanoparticles. The TiO₂@Al₂O₃ nanoparticles were dried at room temperature.

The dried TiO₂@Al₂O₃ nanoparticles were primarily purified with hydrochloric acid, and then, the primarily purified TiO₂@Al₂O₃ nanoparticles were secondarily purified with water and ethanol. The secondarily purified TiO₂@Al₂O₃ nanoparticles were vacuum dried at 60° C.

### EXAMPLE 1

100 parts by weight of the prepared Ti—SiO₂@Al₂O₃ nanoparticles were mixed with 100 parts by weight of the prepared photocurable composition to prepare a solid electrolyte paste.

The prepared solid electrolyte paste was uniformly and thinly coated to a lithium (Li) metal foil (Honjo Chemicals), and irradiation with ultraviolet rays was performed at 2,000 mW/cm⁻² for 30 seconds, thereby forming a solid electrolyte cured layer.

The prepared cathode slurry was uniformly coated to the solid electrolyte cured layer by a doctor blade method, and then, irradiation with ultraviolet rays was performed under the same conditions as described above, thereby manufacturing an all-solid-state lithium-metal battery.

### EXAMPLE 2

Example 2 was performed in the same manner as that of Example 1, except that TiO₂@Al₂O₃ nanoparticles were used instead of the Ti—SiO₂@Al₂O₃ nanoparticles.

### EXAMPLE 3

Example 3 was performed in the same manner as that of Example 1, except that SiO₂@Al₂O₃ nanoparticles were used instead of the Ti—SiO₂@Al₂O₃ nanoparticles.

### EXAMPLE 4

Example 4 was performed in the same manner as that of Example 1, except that Ti—SiO₂@Al₂O₃ nanoparticles were mixed in an amount of 325 parts by weight with respect to 100 parts by weight of the photocurable composition.

### EXAMPLE 5

Example 5 was performed in the same manner as that of Example 1, except that Ti—SiO₂@Al₂O₃ nanoparticles were mixed in an amount of 900 parts by weight with respect to 100 parts by weight of the photocurable composition.

### EXAMPLE 6

Example 6 was performed in the same manner as that of Example 1, except that Al₂O₃ nanoparticles were used instead of the Ti—SiO₂@Al₂O₃ nanoparticles.

### Comparative Example 1

Comparative Example 1 was performed in the same manner as that of Example 6, except that ethoxylated trimethylolpropane triacrylate was added instead of DADMA-LiTFSI when preparing the photocurable composition.

### Comparative Example 2

Comparative Example 2 was performed in the same manner as that of Example 1, except that ethoxylated trimethylolpropane triacrylate was added instead of DADMA-LiTFSI when preparing the photocurable composition.

### Comparative Example 3

Comparative Example 3 was performed in the same manner as that of Example 1, except that the printing was performed using a stacking method instead of the doctor blade method when manufacturing the all-solid-state lithium-metal battery.

TABLE 1

| | | | Content of | | |
|---|---|---|---|---|---|
| | | | inorganic | | Lithium-ion |
| | | | nanoparticles | Ion | transference |
| | Photocurable | Inorganic | (parts by | conductivity | number |
| | composition | nanoparticles | weight) | (Scm⁻²) | (t_{Li}⁺) |
| Example 1 | DADMA- | Ti- | 100 | 4.04 × 10⁻⁴ | 0.91 |
| | LiTFSI/ETPTA | SiO₂ @ Al₂O₃ | | | |
| Example 2 | DADMA- | TiO₂ @ Al₂O₃ | 100 | 3.45 × 10⁻⁴ | 0.82 |
| | LiTFSI/ETPTA | | | | |
| Example 3 | DADMA- | SiO₂ @ Al₂O₃ | 100 | 3.13 × 10⁻⁴ | 0.79 |
| | LiTFSI/ETPTA | | | | |
| Example 4 | DADMA- | Ti- | 325 | 9.41 × 10⁻⁵ | 0.93 |
| | LiTFSI/ETPTA | SiO₂ @ Al₂O₃ | | | |
| Example 5 | DADMA- | Ti- | 900 | 4.67 × 10⁻⁵ | 0.95 |
| | LiTFSI/ETPTA | SiO₂ @ Al₂O₃ | | | |
| Example 6 | DADMA- | Al₂O₃ | 100 | 3.09 × 10⁻⁴ | 0.74 |
| | LiTFSI/ETPTA | | | | |
| Comparative | ETPTA | Al₂O₃ | 100 | 1.61 × 10⁻⁴ | 0.41 |
| Example 1 | | | | | |
| Comparative | ETPTA | Ti- | 100 | 2.22 × 10⁻⁴ | 0.62 |
| Example 2 | | SiO₂ @ Al₂O₃ | | | |
| Comparative | DADMA- | Ti- | 100 | 4.04 × 10⁻⁴ | 0.91 |
| Example 3 | LiTFSI/ETPTA | SiO₂ @ Al₂O₃ | | | |

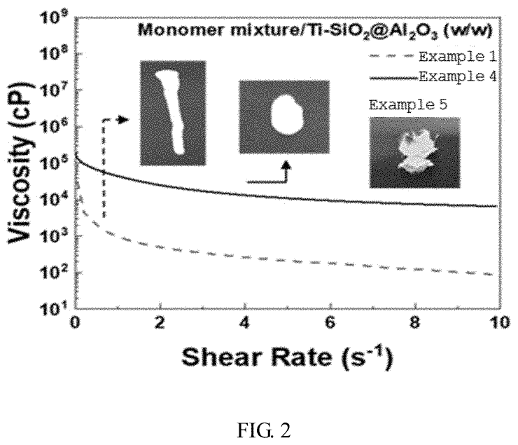

FIG. 2 is a graph showing viscosities of solid electrolyte pastes of Examples 1, 4, and 5. It was measured that the viscosity value in Example 1 was 10⁴ cP or less, and the viscosity value in Example 4 was 10⁴ cP or more. In Example 5, the viscosity could not be measured.

In Example 1, the solid electrolyte paste was easily coated by a doctor blade due to a low viscosity, but in Example 4, it was difficult for the solid electrolyte paste to be uniformly coated, and in Example 5, the solid electrolyte paste was not coated.

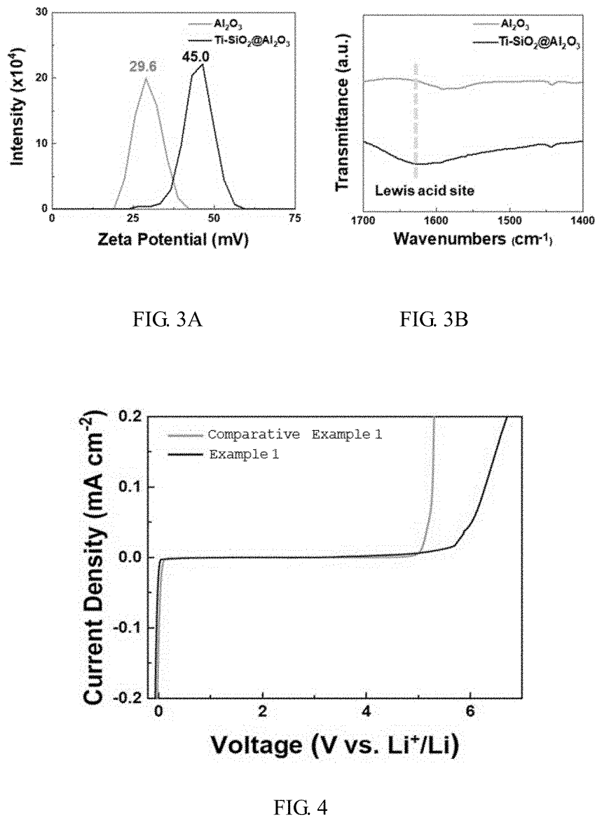

In addition, FIG. 3A illustrates measured zeta potential values of the Ti—Si₂@Al₂O₃ nanoparticles of Example 1 and the Al₂O₃ nanoparticles of Example 6. It was measured that the zeta potential value of the Ti—SiO₂@Al₂O₃ nanoparticles of Example 1 was greater than the zeta potential value of the Al₂O₃ nanoparticles of Example 6. In addition, regarding the FT-IR value illustrated in FIG. 3B, a peak of 1,656 cm⁻¹, which was a Lewis acid peak, was observed in the Ti—SiO₂@Al₂O₃ nanoparticles of Example 1. Therefore, it could be appreciated through the zeta potential values and the FT-IR analysis that the surface of the Ti—SiO₂@Al₂O₃ nanoparticle of Example 1 was further substituted with a Lewis acid.

FIG. 4 is a graph obtained by measuring current densities according to voltages of solid electrolytes of Example 1 and Comparative Example 1. It could be appreciated through the graph that the oxidation potential value in Example 1 was greater than that in Comparative Example 1 at 5 V, and thus, the electrochemical stability in Example 1 was superior to that in Comparative Example 1 even at a high voltage.

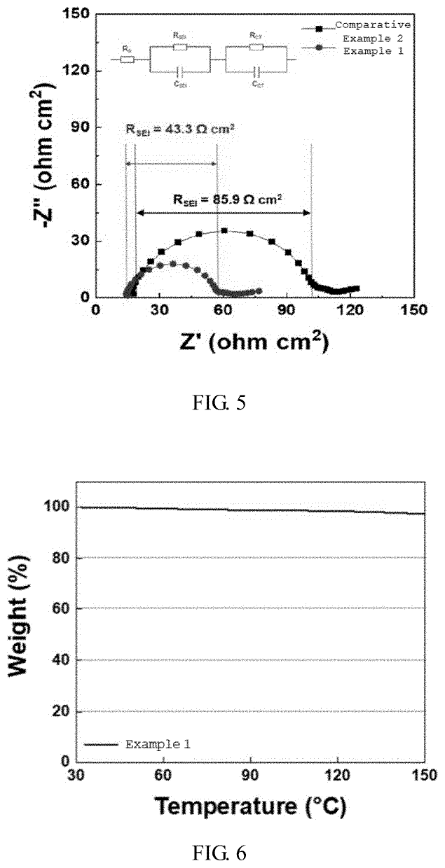

FIG. 5 is a graph obtained by comparing impedance values of Example 1 and Comparative Example 4 through the EIS spectrum graph.

In FIG. 5, the cell impedance value in Example 1 is lower than that in Comparative Example 4, and thus, it can be appreciated that the interfacial contact between the lithium-metal foil and the solid electrolyte in Example 1 is closer than that in Comparative Example 4.

FIG. 6 is a graph obtained by thermogravimetric analysis (TGA) of the solid electrolyte paste of Example 1. As shown in the graph, it can be appreciated that there is almost no reduction in mass even at 150° C., and thus, it can be appreciated that the thermal stability of the solid electrolyte paste is excellent.

As set forth above, the single-ion conducting polymer solid electrolyte has excellent ion conductivity and lithium-ion transference number, and also has excellent mechanical strength and flexibility.

Further, the printing technique is used in the method of manufacturing an all-solid-state lithium-metal battery according to the present disclosure, such that the all-solid-state lithium-metal battery may be manufactured at room temperature and normal pressure, and the interface between the electrolyte and the electrode may be integrated by the above method.

Therefore, an interfacial resistance with an anode may be low, and generation of dendrites in the all-solid-state lithium-metal battery may be suppressed.

Further, since the all-solid-state lithium-metal battery according to the present disclosure has oxidation stability at up to 6 V, a high-capacity cathode material such as NCM811 may be used.

Hereinabove, although the present disclosure has been described by specific matters, limited exemplary embodiments, and drawings, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to the described exemplary embodiments, but the claims and all modifications equal or equivalent to the claims are intended to fall within the spirit of the present disclosure.

1. A single-ion conducting polymer solid electrolyte comprising: a network polymer, inorganic nanoparticles, and an electrolyte, wherein the network polymer contains a structural unit containing a cationic group.

2. The single-ion conducting polymer solid electrolyte of claim 1, wherein the cationic group includes a quaternary ammonium group.

3. The single-ion conducting polymer solid electrolyte of claim 1, wherein the inorganic nanoparticles are cationic inorganic nanoparticles.

4. The single-ion conducting polymer solid electrolyte of claim 1, wherein the network polymer is polymerized from a photocurable composition containing a cationic monomer and a polyfunctional monomer.

5. The single-ion conducting polymer solid electrolyte of claim 4, wherein a ratio of a molar content of the cationic monomer to a total molar content of the photocurable composition is 10 to 70 mol %.

6. The single-ion conducting polymer solid electrolyte of claim 4, wherein the cationic monomer contains two or more polymerizable functional groups.

7. The single-ion conducting polymer solid electrolyte of claim 4, wherein the polyfunctional monomer is a polyol ester-based acrylic compound.

8. The single-ion conducting polymer solid electrolyte of claim 4, wherein the inorganic nanoparticles and the electrolyte are contained in the single-ion conducting polymer solid electrolyte in amounts of 10 to 300 parts by weight and 50 to 300 parts by weight, respectively, with respect to 100 parts by weight of the photocurable composition.

9. The single-ion conducting polymer solid electrolyte of claim 3, wherein the cationic inorganic nanoparticles are coated with a metal oxide layer.

10. The single-ion conducting polymer solid electrolyte of claim 9, wherein the metal oxide layer contains titanium dioxide and silicon dioxide.

11. The single-ion conducting polymer solid electrolyte of claim 1, wherein the single-ion conducting polymer solid electrolyte has an ion conductivity of 1.0×10⁻⁷ to 1.0×10⁻² S/cm and a lithium-ion (Li⁺) transference number of 0.5 to 1.0.

12. A lithium-metal battery comprising the single-ion conducting polymer solid electrolyte of claim 1.

13. The lithium-metal battery of claim 12, wherein the lithium-metal battery is operated at 4.0 V or higher.

14. A method of preparing a single-ion conducting polymer solid electrolyte, the method comprising:
mixing inorganic nanoparticles with a curable composition containing a polyfunctional monomer, a cationic monomer, and an electrolyte; and curing the curable composition in which the inorganic nanoparticles are dispersed.

15. A method of manufacturing an all-solid-state lithium-metal battery, the method comprising:
mixing inorganic nanoparticles with a first curable composition containing a polyfunctional monomer, a cationic monomer, and an electrolyte;
forming a first curable composition layer by printing the first curable composition in which the inorganic nanoparticles are dispersed on a lithium-metal layer;
preparing a single-ion conducting polymer solid electrolyte by curing the first curable composition layer;
forming a cathode layer by printing a cathode slurry containing a cathode active material, a conducting agent, and a second curable composition on the single-ion conducting polymer solid electrolyte; and curing the cathode layer.

16. The method of claim 15, wherein the second curable composition contains a polyfunctional monomer, a cationic monomer, and an electrolyte.

17. The method of claim 14, wherein the curing is performed by light irradiation.
